(19) United States
(12) Patent Application Publication
(10) Pub. No.: US 2014/0052801 A1
(43) Pub. Date: Feb. 20, 2014

(54) METHOD FOR TRANSMITTING MESSAGES IN INSTANT MESSAGING, CLIENT AND STORAGE MEDIUM THEREOF

(71) Applicant: Tencent Technology (Shenzhen) Company Limited, Shenzhen (CN)

(72) Inventors: Xiaoxiang ZUO, Shenzhen (CN); Tao Luan, Shenzhen (CN)

(73) Assignee: Tencent Technology (Shenzhen)Company Limited, Shenzhen (CN)

(21) Appl. No.: 14/051,203

(22) Filed: Oct. 10, 2013

Related U.S. Application Data
(63) Continuation of application No. PCT/CN2012/071905, filed on Mar. 5, 2012.

(30) Foreign Application Priority Data
Apr. 14, 2011 (CN) 201110093729.4

(51) Int. Cl. H04L 12/58

(52) U.S. Cl. CPC H04L 51/04
USPC 709/206

(57) ABSTRACT

A method for transmitting messages in instant messaging, an instant messaging client, and a storage medium. An instant messaging client receives a conversation message including text content from a remote instant messaging client. The conversation message includes a font sign of an individualized font. The instant messaging client receives the font sign from the conversation message. The instant messaging client calls a profile of the individualized font corresponding to the font sign according to the font sign. The instant messaging client makes a composition of the individualized font profile with the text content contained in the conversation message, and displays the composition. The individualized fonts could be dynamically composed according to the text contents of the conversation message and the individualized font profile corresponding to the font sign.

### CROSS-REFERENCE TO RELATED APPLICATIONS

This application is a continuation application of International Application PCT/CN2012/071905, filed Mar. 5, 2012, which claims priority to Chinese application CN 201110093729.4 filed Apr. 14, 2011, which are incorporated herein by reference in their entireties.

### FIELD OF THE INVENTION

The present disclosure relates generally to the field of computer communication technology, and more particularly, to a method for transmitting messages in instant messaging, and a client, and a storage medium thereof.

### BACKGROUND OF THE INVENTION

Web-based instant messaging tools have earned wide acceptance for most of the web users nowadays. For instance, QQ, TM (TENCENT Messenger), MSN (MICROSOFT Service Network), RTX (Real Time Expert) etc, have become essential software tools for users to communicate not only in their daily entertainment, but also in their work environment. The fundamental function of the instant messaging is to communicate and exchange information with contacts. Typically, with existing instant messaging tools, when contacts communicate with each other, especially through words, the fonts appear too undistinguished and even dull. As a result, users are not provided with an attractive visual effect.

There was another technical solution which provided users the possibility to input and transmit characters in the format of pictures. When clients of the instant messaging transmit data, the characters in the format of pictures are transmitted to the other client of the current communication. Therefore, the related contents could only be displayed when the remote client has downloaded the relative picture format from the server, otherwise an error would occur. This kind of communication would require the clients of the instant messaging to have a relatively large memory. The transmission of the characterized pictures would require a large transmission resource to send the content of the pictures to the remote clients. A conflict between the limited transmission bandwidth, memory and users' individualized demands exists, and this conflict needs to be solved.

### SUMMARY OF THE INVENTION

For addressing the technical problem that the individualized demand could not be met when users operate instant messaging tools from the existing technology, it is provided, by embodiments, a method for transmitting messages in instant messaging. The method includes:

an instant messaging client receiving a conversation message including text content from a remote instant messaging client; which conversation message including a font sign of an individualized font;

the instant messaging client resolving the font sign from the conversation message;

the instant messaging calling a profile of the individualized font corresponding to the font sign according to the font sign; and

the instant messaging client making a composition of the individualized font profile with the text content contained in the conversation message, and displaying the composition.

Correspondingly, it is provided, by embodiments, an instant messaging client that performs as a client for receiving conversation messages. The instant messaging client includes:

a conversation message receiving module for receiving conversation messages which contains text contents from the other end client of the instant messaging communication, the conversation message including font signs for the individualized fonts;

a font sign resolving module for resolving the font signs from the conversation messages;

a configuration profile calling module for calling configuration profiles of the individualized fonts corresponding to the font signs, according to the resolved font signs;

an individualized font composing module for composing the text contents included in the received conversation messages with the individualized font configuration profiles;

a conversation message displaying module for displaying the conversation messages that are constituted by the individualized fonts that are composed by the individualized font composing module.

It is provided, by embodiments, an instant messaging client that performs as a client for sending conversation messages. The instant messaging client includes:

a font sign capturing module for capturing the font signs of the individualized font that the user is using when inputting the text contents;

a font initializing module for performing an initiation operation to the text contents that the user has inputted according to the font signs that the font sign capturing module has captured;

a configuration profile caching module for caching locally the individualized font configuration profiles corresponding to the font signs after the font initializing module has performed the initiation operation to the user inputted text contents;

an individualized font composing module for composing the text content that the user is about to send with the individualized font configuration profiles, and for sequentially displaying in the conversation window the compositions;

a conversation message sending module for sending the text contents and the font signs of the individualized fonts to a receiving client of the instant messaging communication.

It is also provided, by embodiments, a method for transmitting messages in instant messaging, which method includes:

an instant messaging client capturing a font sign for an individualized font that the user is using when the user inputs text content;

the instant messaging client carrying an initiation operation on the text content that the user has inputted according to the font sign;

the instant messaging client caching locally an individualized font configuration profile corresponding to the font sign after performing the initiation operation to the user inputted text content;

the instant messaging client composing the individualized font configuration profile with the text content that the user has inputted and is about to be sent, and displaying the composition;

the instant messaging client transmitting the text content with the font sign of the individualized font to a client of the instant messaging that receives the conversation message.

It is provided, by embodiments, one or more storage medium including an executable program, the executable program used for performing a method for transmitting messages in instant messaging, which method includes:

an instant messaging client receiving a conversation message containing text content from a remote instant messaging client; which conversation message including a font sign of an individualized font;

the instant messaging client resolving the font sign from the conversation message;

the instant messaging calling a profile of the individualized font corresponding to the font sign according to the font sign; and

the instant messaging client making a composition of the individualized font profile with the text content included in the conversation message, and displaying the composition.

Through the current disclosure, as it is required to draw the texts, the individualized fonts could be dynamically composed according to the text contents of the conversation message and the individualized font profile corresponding to the font sign; which would not consume the local memory of the instant messaging client. It is needed only the text content to be transmitted when conversation messages are communicated, whereby transmission resources could be saved and transmission speed could be improved, while user experience and performance could be improved.

### BRIEF DESCRIPTION OF THE DRAWINGS

For clear description of embodiments, drawings are hereby introduced. It is clear that the drawings in the below description only relate to some of the embodiments of the present disclosure and, for those skilled in the art, other drawing would be obtained according to the described drawings without requiring creative work.

FIG. 1 is a flow diagram of a method of transmitting messages in instant messaging according to a first embodiment;

FIG. 2 is a flow diagram of a method of transmitting messages in instant messaging according to a second embodiment;

FIG. 3 is a flow diagram of a method of transmitting messages in instant messaging according to a third embodiment;

FIG. 4 is a diagram of the instant messaging client according to a first embodiment;

FIG. 5 is a diagram of the instant messaging client according to a second embodiment;

FIG. 6 is a diagram of the instant messaging client according to a third embodiment;

FIG. 7 is a diagram of the instant messaging client according to a fourth embodiment.

### DESCRIPTION OF EMBODIMENTS

Technical problems that the present disclosure shall solve are that: according to the conventional instant messaging tools, when users communicate, the individualized demands of the users cannot be met through ordinary texts; as well as the problem of occupying transmission resource, and the problem of slow transmission when it is possible to communicate through characterized pictures that requires the transmission of the data of the picture format. For addressing the above problems, the current disclosure provides a method for transmitting messages in instant messaging, and an instant messaging client thereof.

The instant messaging client according to the present disclosure could be clients that are installed in personal computers, tablets, mobile phones, portable media players etc. for instant messaging. The instant messaging client could also be web clients that are operated on personal computers, tablets, mobile phones, portable media players, etc, while it shall not be limited to the above embodiments.

Referring to FIG. 1, a flow diagram of a method of transmitting messages in instant messaging according to a first embodiment is provided.

The method includes, in detail:

Step 100, an instant messaging client receives a conversation message including text content from a remote instant messaging client; which conversation message includes also the font sign of the individualized font;

Step 101, the instant messaging client resolves the font sign from the conversation message;

Step 102, the instant messaging calls, according to the font sign, a profile of the individualized font corresponding to the font sign;

Step 103, the instant messaging client makes a composition of the individualized font profile with the text content included in the conversation message, and displays the composition.

Through the current disclosure, it needs only the text content and the individualized font sign to be transmitted when conversation messages are communicated, whereby transmission resources could be saved and transmission speed could be improved. When displaying the individualized fonts, the individualized fonts could be dynamically composed, as it is required to draw the texts, according to the text contents of the conversation message and the individualized font profile corresponding to the font sign; which enables the individualized characters to be displayed in the conversation window instead of consuming the local memory of the instant messaging client. It is therefore met the individualized requirements of the users while improved the performance for the usage.

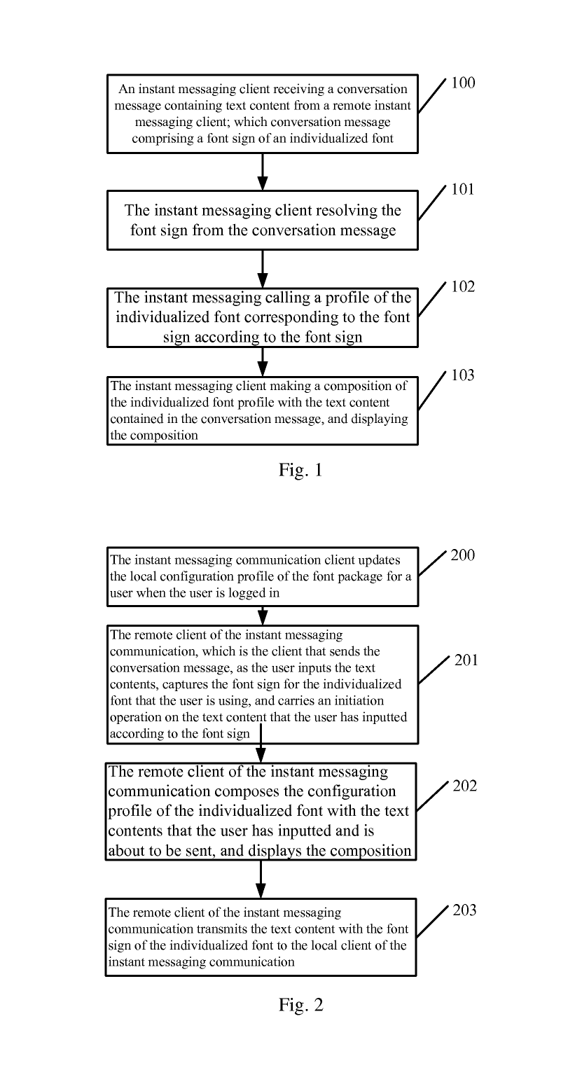

Referring to FIG. 2, a flow diagram of a method of transmitting messages in instant messaging according to a second embodiment is provided.

In the current embodiment, this description would focus on the method flow for a remote client of the instant messaging communication to transmit the individualized font to the local end of the instant messaging communication client, which in detail includes as follows.

Step 200, the instant messaging communication client updates the local configuration profile of the font package for a user when the user is logged in. It shall be mentioned that, each configuration profile of the corresponding package of individualized font is recorded in XML (Extensible Markup Language). It is needed to update the configuration profile in the server when it's required for the operation of any follow up product or upgrade thereof. It's clear that this would be one exemplary embodiment while the configuration profile shall be recorded in other formats.

It shall also be mentioned that this Step 200 could be skipped to carry out Step 201 directly while the local configuration profile of the font package for the user is not updated. Step 201, the remote client of the instant messaging communication, which is the client that sends the conversation message, as the user inputs the text contents, captures the font sign for the individualized font that the user is using, and carries an initiation operation on the text content that the user has inputted according to the font sign. In detail, the initiation operation on the user inputted text content includes: initiate a background picture for the font, initiate a switching frequency for a dynamic font, configuring sizes of the font for each frame, the type of the font, and draw coordinates, etc.

Step 202, the remote client of the instant messaging communication composes the configuration profile of the individualized font with the text contents that the user has inputted and is about to be sent, and displays the composition.

To be more definite, the remote client of the instant messaging communication uses relative modules corresponding to the type of composition of the font according to the configuration profile of the individualized fonts, to compose sequential png picture with Alpha transparency. It shall be mentioned that the Alpha color channel is an 8-bit grayscale channel which uses 256 degrees of grayscale to record the transparency information of the picture, thereby defining the transparent, semitransparent, and opaque area, wherein black would stand for transparent, while would stand for opaque, while gray would stand for semitransparent. Png is a kind of storage format for pictures. Moreover, each letter or character in the conversation message would be corresponding to an OLE (Object Linking and Embedding) control. Each OLE control holds a png picture of the font that is composed thereby. A conversation message manager corresponding to each conversation message holds all the OLE controls of the conversation message, while the conversation message manager is in charge of the dynamic processing of the conversation message (for example, start, stop, dynamic frequency switch, etc.). After the composition, the text with the individualized font would be displayed in the conversation window, whereby the user of the other end client of the instant messaging would be displayed with the outcomes of the individualized font that is transmitted.

In an embodiment, after the remote client carries the initiation operation on the text content that the user has inputted, the configuration profile of the individualized font could be cached locally. Sequentially, in Step 202, when the remote client of the instant messaging communication composes the configuration profile of the individualized font with the text contents that the user has inputted, the locally cached configuration profile of the individualized font would be used for the composition.

Step 203, the remote client of the instant messaging communication transmits the text content with the font sign of the individualized font to the local client of the instant messaging communication.

Through the current disclosure, on the sending end of the instant messaging, after the user inputs texts using individualized fonts, the instant messaging client could dynamically compose the individualized fonts according to the message text contents and the configuration profile for the individualized fonts corresponding to the font sign when drawing the texts, which would not consume the local storage of the instant messaging clients. This would not only meet the individualized demand of the users but also improved the user experience and performance. It is needed to transmit only the text content and the individualized font sign when the instant messaging clients transmits the conversation messages, which would save the transmission resource while improves the speed for the transmission.

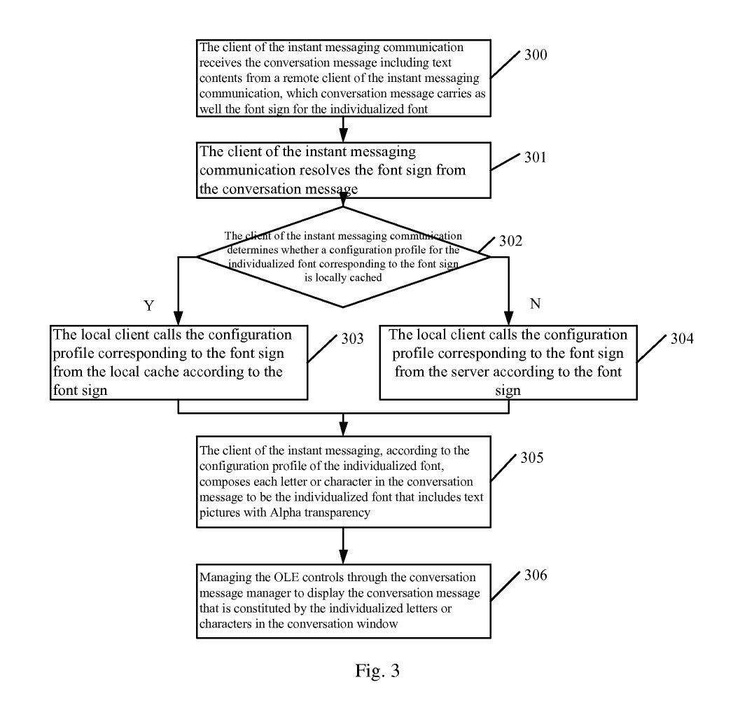

Referring to FIG. 3, a flow diagram of a method of transmitting messages in instant messaging according to a third embodiment is provided.

In the current embodiment, this description would focus on the method flow for a local client of the instant messaging communication to receive the individualized font, which in detail includes as follows.

Step 300, the client of the instant messaging communication receives the conversation message including text contents from a remote client of the instant messaging communication, which conversation message carries as well the font sign for the individualized font.

Step 301, the client of the instant messaging communication resolves the font sign from the conversation message.

Step 302, the client of the instant messaging communication determines whether a configuration profile for the individualized font corresponding to the font sign is locally cached, according to the font sign. Step 303 is followed if it is cached, or step 304 is followed otherwise.

Step 303, if the configuration profile is cached locally in the local client of the instant messaging, the local client would call the configuration profile corresponding to the font sign from the local cache according to the font sign.

Step 304, if the configuration profile is not cached locally in the local client of the instant messaging, the local client would call the configuration profile corresponding to the font sign from the server according to the font sign.

Step 305, the client of the instant messaging, according to the configuration profile of the individualized font, composes each letter or character in the conversation message to be the individualized font that includes text pictures with Alpha transparency. In detailed, each composed individualized letter or character is controlled by a corresponding OLE control, and the conversation message is managed through a conversation message manager.

Step 306, managing the OLE controls through the conversation message manager to display the conversation message that is constituted by the individualized letters or characters in the conversation window.

What shall be mentioned here is that, for the improvement of the performance, those conversation messages that are invisible in the available area of the conversation window of the instant message communication would not be composed to be the individualized fonts, while only visible messages are needed to be composed.

Through the current disclosure, at the local client of the instant messaging communication, the local client would dynamically compose individualized fonts according to the individualized font configuration profile corresponding to the message text content and the font sign when drawing the text, which would not consume the local storage of the instant messaging clients. This would not only meet the individualized demand of the users but also improved the user experience and performance.

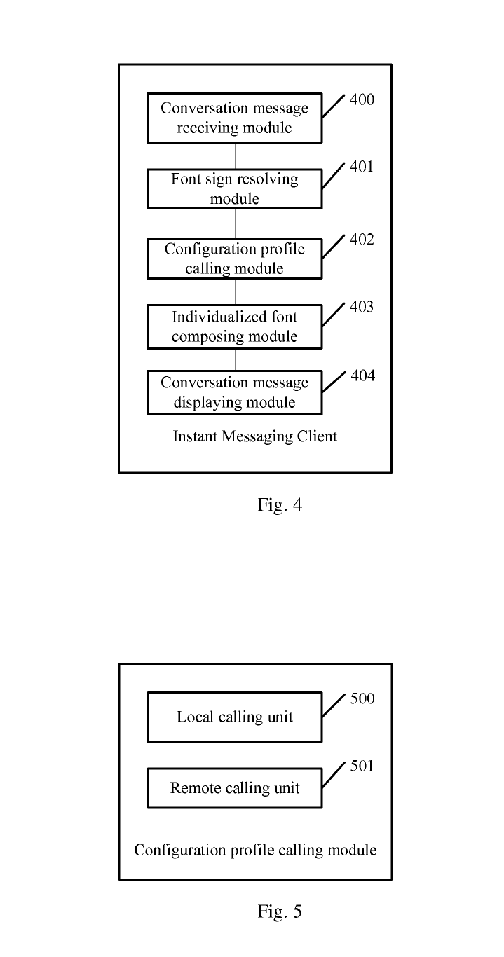

Referring to FIG. 4, a diagram of the instant messaging client according to a first embodiment is provided.

The client in accordance with the current embodiment would perform as the receiving end of the conversation message while in the conversation process. The client includes as follows.

A conversation message receiving module 400 is used for receiving conversation messages which includes text contents from the other end client of the instant messaging communication, the conversation message includes also font signs for the individualized fonts.

A font sign resolving module 401 is used for resolving the font sign from the conversation message.

A configuration profile calling module 402 is used for calling configuration profile of the individualized font corresponding to the font sign, according to the resolved font sign.

An individualized font composing module 403 is used for composing the text content included in the received conversation message with the individualized font configuration profile. In detail, the individualized font composing module 403 relatively composes each letter or character included in the text content of the conversation message to be a text picture with Alpha transparency, according to the individualized font configuration profile.

A conversation message displaying module 404 is used for displaying the conversation message that is constituted by the individualized fonts that are composed by the individualized font composing module 403.

Through the current disclosure, the client of the instant messaging communication would transmit only the text content and the individualized font sign when transmitting the conversation message, which would save the transmission resource while improve the transmission speed. When displaying the individualized fonts, a real-time dynamic composition of the individualized fonts would be carried according to the text content of the conversation message and the individualized font configuration profile corresponding to the font sign thereof, and then the individualized font could be displayed in the conversation window, which would need no consumption of the storage of the local client of the instant messaging communication. User's individualized demand could thereby be met while user experience could be improved greatly.

Referring to FIG. 5, a diagram of the instant messaging client according to a second embodiment is provided.

This embodiment would further describe the detailed composition of the configuration profile calling module of client of the instant messaging when performing as the receiving end of the conversation message, which includes as follows.

A local calling unit 500 is used for, when the individualized font configuration profile is cached locally in the communication client, calling the individualized font configuration profile corresponding to the font sign from the local cache according to the font sign.

A remote calling unit 501 is used for, when the individualized font configuration profile is not cached locally in the communication client, calling the individualized font configuration profile corresponding to the font sign from the server according to the font sign.

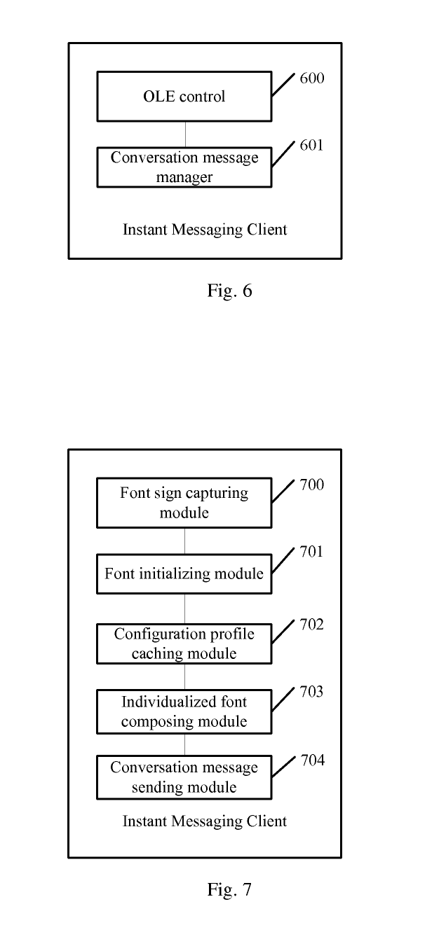

Referring to FIG. 6, a diagram of the instant messaging client according to a third embodiment is provided.

The instant messaging client according to the current embodiment includes the modules as in the previous embodiment (not illustrated herein), and further includes as follows.

An OLE control 600 is used for controlling each text picture that is composed by the individualized font composing module.

A conversation message manager 601 is used for controlling the OLE control 600, for displaying in the conversation window the conversation message that is constituted by the text pictures with Alpha transparency that are composed by the individualized font composing module.

What shall be mentioned here is that, for the improvement of the performance, those conversation messages that are invisible in the available area of the conversation window of the instant message communication would not be composed to be the individualized fonts, while only visible messages are needed to be real-time composed.

Through the current disclosure, at the local client of the instant messaging communication, the local client would dynamically compose individualized fonts according to the individualized font configuration profile corresponding to the message text content and the font sign when drawing the text, which would not consume the local storage of the instant messaging clients. This would not only meet the individualized demand of the users but also improved the user experience and performance.

Referring to FIG. 7, a diagram of the instant messaging client according to a fourth embodiment is provided.

The instant messaging client could perform as the client for sending the conversation message in the conversation, which would include as follows.

A font sign capturing module 700 is used for capturing the font sign of the individualized font that the user is using when inputting the text contents. It shall be mentioned that, when the user is logged in, the instant messaging client would by default update the configuration profile of the local font package for the user.

A font initializing module 701 is used for performing the initiation operation to the text contents that the user has inputted according to the font sign that the font sign capturing module has captured. In detail, the initiation operation to the user inputted text contents include: initiate a background picture for the font, initiate a switching frequency for a dynamic font, configuring sizes of the font for each frame, the type of the font, and draw coordinates, etc.

A configuration profile caching module 702 is used for caching locally the individualized font configuration profile corresponding to the font sign after the font initializing module 701 has performed the initiation operation to the user inputted text contents.

An individualized font composing module 703 is used for composing the text content that the user is about to send with the individualized font configuration profile, and sequentially displaying in the conversation window the composition.

To be more definite, the individualized font composing module 703 would use relative modules corresponding to the type of composition of the font according to the configuration profile of the individualized fonts to compose sequential png picture with Alpha transparency. Each letter or character in the conversation message would be corresponding to an OLE (Object Linking and Embedding) control. Each OLE control holds a png picture of the font that is composed thereby. A conversation message manager corresponding to each conversation message holds all the OLE controls of the conversation message, while the conversation message manager is in charge of the dynamic processing of the conversation message (for example, start, stop, dynamic frequency switch, etc.) The text with the individualized font would be displayed in the conversation window, whereby the user of the other end client of the instant messaging would be displayed with the outcomes of the individualized font that is transmitted.

A conversation message sending module 704 is used for sending the text contents and the font signs of the individualized fonts to the receiving client of the instant messaging communication.

Through the current disclosure, on the sending end of the instant messaging, after the user inputs texts using individualized fonts, the instant messaging client could dynamically compose the individualized fonts according to the message text contents and the configuration profile for the individualized fonts corresponding to the font sign when drawing the texts, which would not consume the local storage of the instant messaging clients. This would not only meet the individualized demand of the users but also improved the user experience and performance. It is needed to transmit only the text content and the individualized font sign when the instant messaging clients transmits the conversation messages, which would save the transmission resource while improves the speed for the transmission.

It is provided according to the current disclosure one or more storage medium that include executable program thereon. The executable program is used to carry out a method for transmitting conversation messages in instant messaging communication, which includes steps of: an instant messaging client receives a conversation message including text content from a remote instant messaging client; which conversation message includes also the font sign of the individualized font; the instant messaging client resolves the font sign from the conversation message; the instant messaging calls, according to the font sign, a profile of the individualized font corresponding to the font sign; the instant messaging client makes a composition of the individualized font profile with the text content included in the conversation message, and display the composition.

According to one of the embodiments, the remote client of the instant messaging communication captures the font sign for the individualized font that the user is using when the user inputs the text contents, and carries an initiation operation on the text content that the user has inputted according to the font sign.

Further, the remote client of the instant messaging caches locally the individualized font configuration profile corresponding to the font sign after performing the initiation operation to the user inputted text contents.

Further, the remote client of the instant messaging, after caching locally the individualized font configuration profile corresponding to the font sign, composes the text content that the user is about to send with the individualized font configuration profile, and sequentially displays in the conversation window the composition.

Further, the remote client of the instant messaging, after composing the text content that the user is about to send with the individualized font configuration profile, and sequentially displaying in the conversation window the composition, transmits the text content with the font sign of the individualized font to the instant messaging client.

According to one of the embodiments, the instant messaging client calls the individualized font configuration profile corresponding to the font sign according to the font sign, which includes:

if the configuration profile is cached locally in the local client of the instant messaging, the instant messaging client would call the configuration profile corresponding to the font sign from the local cache according to the font sign;

if the configuration profile is not cached locally in the local client of the instant messaging, the instant messaging client would call the configuration profile corresponding to the font sign from the server according to the font sign.

Further, the instant messaging client composes the configuration profile of the individualized font with the received text contents, and displays the composition in the conversation window, which includes:

the instant messaging client composes each letter or character in the conversation message to be the individualized font that includes text pictures with Alpha transparency according to the configuration profile of the individualized font, each composed individualized letter or character is controlled by a corresponding OLE control;

the conversation message is managed through a conversation message manager, the conversation message manager display the conversation message that is constituted by the individualized letters or characters in the conversation window through managing the OLE controls.

Those skilled in the art could understand that the whole or part of the flows included in the method of the above embodiments could be accomplished by relative hardware under instruction of computer programs. The programs could be stored in computer readable storage medium. The flows as in the methods of the above embodiments would be performed by executing the program. The storage medium could be magnetic disks, optical disks, read-only memories, or random access memories, etc.

The above described embodiments explain only several exemplary embodiments of the present disclosure. It shall be mentioned that for those skilled in the art, alternative embodiments could be made to which the present disclosure pertains without departing from its spirit and scope, wherein the alternative embodiments shall be defined as within the claim of the current disclosure.

What is claimed is:

1. A method for transmitting messages in instant messaging, the method comprising:
receiving, by an instant messaging client, a conversation message including text content from a remote client and a font sign of an individualized font;
resolving, by the instant messaging client, the font sign from the conversation message;
calling, by the instant messaging client, a configuration profile of the individualized font corresponding to the font sign, according to the resolved font sign; and
making, by the instant messaging client, a composition of the configuration profile of the individualized font with the text content included in the conversation message, and displaying the composition.

2. The method for transmitting messages in instant messaging according to claim 1, further comprising:
capturing, by the remote client, the font sign for the individualized font that a user is using when the user inputs the text content, and carries an initiation operation on the text content that the user has inputted according to the font sign.

3. The method for transmitting messages in instant messaging according to claim 2, further comprising:
locally caching, by the remote client, the configuration profile of the individualized font corresponding to the font sign after performing the initiation operation to the user inputted text content.

4. The method for transmitting messages in instant messaging according to claim 3, further comprising:
composing, by the remote client, the text content that the user is about to send with the configuration profile of the individualized font, and sequentially displaying, in a conversation window, the composition after caching locally the configuration profile of the individualized font corresponding to the font sign.

5. The method for transmitting messages in instant messaging according to claim 4, further comprising:
transmitting, by the remote client, the text content with the font sign of the individualized font to the instant messaging client after composing the text content that the user is about to send with the configuration profile of the individualized font and sequentially displaying, in the conversation window, the composition.

6. The method for transmitting messages in instant messaging according to claim 1, wherein said calling comprises:
if the configuration profile is cached locally in a local cache of the instant messaging client, calling, by the instant messaging client, the configuration profile corresponding to the font sign from the local cache;
if the configuration profile is not cached locally in a local cache of the local client, calling, by the instant messaging client, the configuration profile corresponding to the font sign from a server.

7. The method for transmitting messages in instant messaging according to claim 1, wherein
the conversation message is managed through a conversation message manager;
said making a composition comprises:
composing, by the instant messaging client, each letter or character in the conversation message to be the individualized font that contains text pictures with Alpha transparency according to the configuration profile of the individualized font, each composed letter or character being controlled by a corresponding Object Linking and Embedding (OLE) control; and
said displaying comprises displaying, by the conversation message manager, the conversation message that is constituted by the composed letters or characters in the conversation window through managing of the OLE controls.

8. An instant messaging client comprising:
computing hardware executing instructions of a computer program to provide:
a conversation message receiving module to receive a conversation message from a remote client, the conversation message including text content and a font sign of an individualized font;
a font sign resolving module to resolve the font sign from the conversation message;
a configuration profile calling module to call a configuration profile of the individualized font corresponding to the font sign, according to the resolved font sign;
an individualized font composing module to compose the text content included in the received conversation message with the configuration profile of the individualized font; and
a conversation message displaying module to display the conversation message that is constituted by the text content composed with the configuration profile of the individualized font by the individualized font composing module.

9. The instant messaging client according to claim 8, wherein the configuration profile calling module comprises:
a local calling unit to call the configuration profile of the individualized font corresponding to the font sign from a local cache if the configuration profile of the individualized font is cached locally in the instant messaging client; and
a remote calling unit to call the configuration profile of the individualized font corresponding to the font sign from a server if the configuration profile of the individualized font is not cached locally in the instant messaging client.

10. The instant messaging client according to claim 9, wherein the individualized font composing module composes each letter or character contained in the text content of the conversation message to be a text picture with Alpha transparency according to the configuration profile of the individualized font.

11. The instant messaging client according to claim 10, wherein the instant messaging client further comprises:
an OLE control to control each text picture that is composed by the individualized font composing module; and
a conversation message manager to control the OLE control, and to display, in a conversation window, the conversation message that is constituted by the text picture with Alpha transparency that is composed by the individualized font composing module.

12. An instant messaging client comprising:
computing hardware executing instructions of a computer program to provide:
a font sign capturing module to capture a font sign of an individualized font that a user is using when inputting text content;
a font initializing module to perform an initiation operation to the text content that the user has inputted according to the font sign that the font sign capturing module has captured;
a configuration profile caching module to cache locally a configuration profile of the individualized font corresponding to the font sign after the font initializing module has performed the initiation operation;
an individualized font composing module to compose the text content that the user is about to send with the configuration profile of the individualized font, and to sequentially display, in a conversation window, the composed text;
a conversation message sending module to send the text content and the font sign of the individualized font to a receiving client of an instant messaging communication.

13. A method comprising:
capturing, by an instant messaging client, a font sign of an individualized font that a user is using when the user inputs text content;
carrying, by the instant messaging client, an initiation operation on the text content that the user has inputted according to the font sign;
locally caching, by the instant messaging client, an individualized font configuration profile corresponding to the font sign after performing the initiation operation to the user inputted text content;
composing, by the instant messaging client, the individualized font configuration profile with the text content that the user has inputted and is about to be sent, to thereby provide a composition, and displaying the composition;
transmitting, by the instant messaging client, the text content with the font sign of the individualized font to a client of the instant messaging that receives a conversation message.

14. The method according to claim 13, wherein before said capturing, the method further comprises:
updating, by the instant messaging client, a local configuration profile of a font package for the user when the user is logged in.

15. The method according to claim 13, wherein said composing comprises:
using, by the instant messaging client, a relative module corresponding to a type of composition of the font according to the individualized font configuration profile to compose sequential pictures with Alpha transparencies.

16. One or more non-transitory computer-readable storage medium comprising an executable program that, when executed by computing hardware, performs the following process:
receiving, by an instant messaging client, a conversation message including text content from a remote instant messaging client and a font sign of an individualized font;
resolving, by the instant messaging client, the font sign from the conversation message;
calling, by the instant messaging client, a configuration profile of the individualized font corresponding to the font sign, according to the resolved font sign; and
making, by the instant messaging client, a composition of the configuration profile of the individualized font with the text content included in the conversation message, and displaying the composition.

17. The one or more non-transitory computer-readable storage medium according to claim 16, wherein the process further comprises:
capturing, by the remote client, the font sign of the individualized font that the user is using when the user inputs the text content, and
carrying, by the remote client, an initiation operation on the text content that the user has inputted according to the font sign.

18. The one or more non-transitory computer-readable storage medium according to claim 17, wherein the process further comprises:
locally caching, by the remote client, the configuration profile of the individualized font corresponding to the font sign after performing the initiation operation to the user inputted text content.

19. The one or more non-transitory computer-readable storage medium according to claim 17, wherein the process further comprises:
composing, by the remote client, the text content that the user is about to send with the configuration profile of the individualized font, and
sequentially displaying, by the remote client, in a conversation window, the composition, after said locally caching by the remote client.

20. The one or more non-transitory computer-readable storage medium according to claim 17, wherein the process further comprises:
transmitting, by the remote client, the text content with the font sign of the individualized font to the instant messaging client after composing the text content that the user is about to send with the configuration profile of the individualized font and sequentially displaying in the conversation window the composition.

21. The one or more non-transitory computer-readable storage medium according to claim 16, wherein said calling comprises:
if the configuration profile of the individualized font is cached locally in the instant messaging client, calling, by the instant messaging client, the configuration profile corresponding to the font sign from the local cache; and
if the configuration profile of the individualized font is not cached locally in the instant messaging client, calling, by the instant messaging client, the configuration profile of the individualized font corresponding to the font sign from a server.

22. The one or more non-transitory computer-readable storage medium according to claim 21, wherein
said making a composition comprises:
composing, by the instant messaging client, each letter or character in the conversation message to be the individualized font that contains text pictures with Alpha transparency according to the configuration profile of the individualized font, each composed individualized letter or character being controlled by a corresponding OLE control; and
said process further comprises:
managing the conversation message through a conversation message manager, and
displaying, by the conversation message manager, the conversation message that is constituted by the individualized letters or characters in the conversation window through managing the OLE controls.
